(19) United States
(12) Patent Application Publication
(10) Pub. No.: US 2008/0235568 A1
(43) Pub. Date: Sep. 25, 2008

(54) METHOD AND APPARATUS FOR VISUALIZING MULTIDIMENSIONAL DATA SETS USING EXPANDABLE GRIDS WITH HIERARCHICALLY-LABELED AXES

(75) Inventors: Peter K. Malkin, Ardsley, NY (US); Robert W. Reeder, Mahwah, NJ (US)

Correspondence Address: SCULLY, SCOTT, MURPHY & PRESSER, P.C., 400 GARDEN CITY PLAZA, SUITE 300, GARDEN CITY, NY, 11530, US

(73) Assignee: INTERNATIONAL BUSINESS MACHINES CORPORATION, Armonk, NY (US)

(21) Appl. No.: 12/131,405

(22) Filed: Jun. 2, 2008

Related U.S. Application Data
(63) Continuation of application No. 11/504,302, filed on Aug. 15, 2006.

(51) Int. Cl. G06F 17/00

(52) U.S. Cl. 715/228

(57) ABSTRACT

A system and methodology for visualizing large multidimensional data sets on a display device using an expandable/retractable grid that displays the nodes of multiple levels of a hierarchy simultaneously. The data set is displayed as a grid having at least one hierarchically-labeled axis, each of the grid's at least one labeled axes having labels that represent values or categories of the values of an indexing dimension corresponding to the data set. The method includes selecting a label of at least one of the hierarchically-labeled axes representing an unexpanded hierarchical category and, in response, displaying a hierarchy expansion of a portion of the hierarchy represented by the selected label. Additionally, the method displays a grid expansion relating to the expanded hierarchy portion. Each grid cell of the grid expansion displays a visual representation of one or more data records having values represented by those labels that indicate axis partitions to which the grid cell corresponds.

### CROSS REFERENCE TO RELATED APPLICATIONS

The present application is a continuation application of U.S. Ser. No. 11/504,302, filed Aug. 15, 2006.

### BACKGROUND OF THE INVENTION

1. Field of the Invention

The present invention generally relates to computer systems adapted for viewing large data sets, in which data values are organized into data records, and more particularly, to a system and method for visualization of large multidimensional data sets using expandable/retractable grids that displays the nodes of multiple levels of a hierarchy simultaneously.

2. Description of the Prior Art

In many business, scientific, and computing applications, it is often desirable to view large data sets, in which data values are organized into data records, and data records can be distinguished according to one or more dimensions. With such large data sets, it may be impossible to display a representation of the entire data set in a manner that a person can comprehend; thus, display techniques for aiding human comprehension of detailed but small portions of a data set while still allowing for comprehension of the context of an entire data set are valuable.

Techniques currently exist that address the problem of visualizing large multidimensional data sets in a variety of ways, but do not taken advantage of a common dimensional structure, a hierarchy, that can lead to simplified visualizations. Current techniques are also known that have also addressed the problem of visualizing hierarchies in isolation, but not visualizing hierarchies as indexing dimensions into a large multidimensional data set.

The prior art that has addressed the visualization of large multidimensional data sets include a reference authored by Beshers, C. and S. Feiner entitled AutoVisual: Rule-based Design of interactive Multivariate Visualizations, IEEE Computer Graphics and Applications, 13(4), 41-49, July 1993; and, a reference authored by Shneiderman, et al. entitled Visualizing Digital Library Search Results with Categorical and Hierarchical Axes, University of Maryland technical report number CS-TR-3992, UMIACS-TR-99-12, February 1999. The Beshers and Feiner reference describes a system for browsing a multidimensional data set in three-dimensional space, but they do not teach use of an expandable grid. Shneiderman et al. describes Dotfire, an information visualization tool using discrete variables and hierarchical axes to merge searching and browsing (also known as GRIDL (GRaphical Interface for Digital Libraries), that includes a grid with a hierarchically-labeled axis. However, Dotfire only displayed the nodes of a single level of a hierarchy at one time along an axis.

In the patent literature, U.S. Pat. No. 5,632,009 to Rao et al., U.S. Pat. No. 5,880,742 to Rao et al., and, U.S. Pat. No. 6,085,202 to Rao et al. each describe methods and systems for visualizing multidimensional data sets in a grid, but none teach or suggest the visualization via an expandable grid. U.S. Pat. No. 6,628,312 to Rao et al. provides the idea of hierarchically-labeled axes, but is restricted to displaying a hierarchy of non-hierarchical dimensions along its hierarchically-labeled axes, and does not provide the idea of displaying a single hierarchical dimension along a hierarchically-labeled axis nor the idea of expanding and retracting a grid by adding or removing grid cells as a corresponding axis hierarchy is expanded and retracted.

Other prior art techniques that have addressed the problem of visualizing hierarchies in a variety of ways includes disclosure provided in: the reference authored by Lamping and Rao entitled The hyperbolic browser: a focus+context technique for visualizing large hierarchies in the collection entitled Readings in Information Visualization: Using Vision to Think, by Stuart K. Card, Jock D. Mackinlay, and Ben Shneiderman, 382-408, Academic Press, 1999; the reference authored by Johnson and Shneiderman entitled Tree-Maps: A space-filling approach to the visualization of hierarchical information structures, also found in the collection Readings in Information Visualization: Using Vision to Think, by Stuart K. Card, Jock D. Mackinlay, and Ben Shneiderman, 152-159, Academic Press, 1999; and, the reference authored by Harsha et al entitled Browsing Hierarchical Data with Multi-level Dynamic Queries and Pruning, also in the same collection of Readings in Information Visualization: Using Vision to Think, by Stuart K. Card, Jock D. Mackinlay, and Ben Shneiderman, 295-305, Academic Press, 1999. While these references describe ways for visualizing data sets that are themselves hierarchies, they do not provide methods for visualizing large data sets that are not hierarchies themselves, but have hierarchical dimensions.

It would thus be highly desirable to provide a multidimensional data visualization system and methodology that takes advantage of hierarchically-structured dimensions for simplifying viewing a large multidimensional data set in a grid.

It would further be highly desirable to enable the visualization of hierarchically-arranged multidimensional data that enables the display of nodes of multiple levels of the hierarchy simultaneously, thus preserving more of the context of a complete data set in a single view than currently possible, e.g., with Dotfire.

### SUMMARY OF THE INVENTION

A system, method and computer program product for visualizing large multidimensional data sets using expandable/retractable grids that displays the nodes of multiple levels of a hierarchy simultaneously.

According to one aspect of the invention, there is provided a method for visually representing a data set on a display device, the data set represented as a grid having at least one hierarchically-labeled axis, each of the grid's at least one labeled axes having labels that represent values or categories of the values of an indexing dimension corresponding to the data set, the grid comprising grid cells representing one or more data records of the data set. The method comprises:

displaying, on the display device, a hierarchy expansion of a portion of the hierarchy represented by a selected label;

displaying, on the display device, a grid expansion relating to the expanded hierarchy portion; and,

displaying, in one or more grid cells of the grid expansion, a visual representation of one or more data records having values represented by those labels that indicate axis partitions to which the grid cell corresponds.

Further to the method, there is additionally provided the step of: selecting via the display device, a label of at least one of the hierarchically-labeled axes representing an unexpanded hierarchical category, and displaying said grid expansion in response to said selecting.

Further to the method, the displaying a hierarchy expansion of a portion of the hierarchy comprises:

displaying, on the display device, the selected hierarchy category and those hierarchy nodes having the hierarchy category as a parent.

Further, the method comprises:

selecting a hierarchy category represented by a label of one of the grid's hierarchically-labeled axes;

retracting, on the display, that portion of the hierarchy represented by the labels of the hierarchically-labeled axis, the portion including the selected hierarchy category and those hierarchy nodes having the hierarchy category as a parent; and,

retracting, on the display, that corresponding grid expansion of the hierarchy.

In one embodiment, the visual representation of a displayed grid comprises:

lines displayed in a first orientation perpendicular to a hierarchically-labeled axis to indicate the visual boundaries between adjacent grid cells, the one or more lines indicating the visual boundaries belonging to different grid cell levels having different visual characteristics. A visual characteristic of a displayed line indicating visual boundaries between grid cells belonging to different grid cell levels comprises one or more of: a color, a shading, a pattern, or a thickness.

Furthermore, in one embodiment, a grid cell comprises one of: an atomic grid cell corresponding to a labeled-axis partition indicated by a label that represents a value, or, a composite grid cell corresponding to at least one labeled-axis partition indicated by a label that represents a hierarchy category, a visual representation of data records within a displayed composite grid cell being visually distinct from all visual representations of data records displayed in atomic grid cells. Atomic grid cells correspond to single data records, while composite grid cells correspond to arbitrary combinations of multiple data records; hence, more visual representations may be needed to represent the combinations of data records in composite grid cells than are needed to represent the single data records in atomic grid cells.

In an alternate embodiment, the expandable/retractable grid display generated by the current invention includes grid cells, each of which are further divided into a subgrid. Subgrids have a corresponding dimension, and each cell within each subgrid corresponds to a value in the subgrid's corresponding dimension. Within each cell of each subgrid is a visual representation, such as block of color, indicia or pattern, of one or more data records. The subgrid within each cell thus allows for division amongst represented data records by one more dimension than otherwise allowed by the grid.

Advantageously, the present invention may be useful for viewing large policies, e.g., sets of rules that govern how allocation or access decisions are made. Some example policy domains are resource management policy, in which policies govern the allocation of supplies, services, money, or other resources to entities, privacy policy, in which policies govern who may access sensitive information under what conditions, and computer security policy, in which policies govern who may access computing resources.

For example, policies may be quite large, and hence unwieldy for a policy-making or policy-enforcing person to comprehend. For instance, privacy policies consist of potentially millions of data records, each indicating whether access to sensitive information is allowed or denied in one of potentially millions of cases. These cases are generally specified according to five dimensions: who is requesting access, what type of information (e.g., name, date of birth, transactions, etc.) they are requesting access to, what kind of access they are requesting (e.g., to read the information, to modify the information, to delete the information, etc.), the purpose for which they need information access, and any miscellaneous additional conditions. A large business may have thousands of employees, thousands of information elements, several kinds of access, and dozens of purposes and conditions. Such a business may have a very large policy that is difficult to understand.

The present invention mitigates the difficulty people may have comprehending large policies. If some of the dimensions along which a policy is organized constitute a hierarchy, the present invention can be used to display a policy in a single, unified view, with both the broad context of the entire policy as well as the details of areas of interest viewable simultaneously. Moreover, when implemented on a computer system, the invention can be used to explore a policy dynamically, by changing the areas displayed in detail, so that a policy can be explored by viewing multiple areas of interest in progression.

### BRIEF DESCRIPTION OF THE DRAWINGS

The objects, features and advantages of the present invention will become apparent to one skilled in the art, in view of the following detailed description taken in combination with the attached drawings, in which:

FIG. 1 depicts a hierarchy having values and categories for which the present invention is adapted to enable visualization of;

FIG. 2 depicts a data set having data records for which the present invention is adapted to enable visualization of;

FIG. 3 depicts an example display comprising the visualization of a multidimensional data set generated by the current invention;

FIG. 4 is a block diagram depicting an example implementation of the current invention;

FIG. 5 is a flow chart depicting the flow control of the logic implemented for visualizing multidimensional data sets according to the current invention;

FIG. 6 depicts an example display enabling the visualization of a multidimensional data set as generated by the current invention;

FIG. 7 depicts an example of a display generated by the current invention in which a grid cell has been selected and a larger visual representation of the data record or data records represented in the grid cell is displayed;

FIG. 7A depicts an alternate embodiment wherein an example expandable/retractable grid display generated by the current invention contains grid cells, each of which are further divided into a subgrid;

FIG. 8 depicts a flow control of the detailed logic of Grid Expansion Handler 4050 of FIG. 4; and,

FIG. 9 depicts a flow control of the detailed logic of Grid Retraction Handler 4060 of FIG. 4.

### DETAILED DESCRIPTION OF THE PREFERRED EMBODIMENTS

The present invention is directed to a system and method for visualizing large multidimensional data sets using expandable/retractable grids that displays the nodes of multiple levels of a hierarchy simultaneously. As will be referred to herein, within a data set, data records are organized by dimensions. A dimension is a collection of values that define a single attribute of an object represented by a data record. For instance, a phone book is an example of a data set; each entry in the phone book, including name, phone number, and address, is a data record; a dimension for entries in a phone book would be a collection of last names, while another dimension would be the collection of all unique telephone numbers.

In the visualization of large data sets according to the invention, the following definitions apply:

Object: any concept defined to be of interest by the practitioners of a domain of endeavor.

Value: a unit of information describing an aspect of an object that distinguishes that object from other objects.

Attribute: a property of objects for which different objects may have different values.

Data record: a collection of values representing a specific object, where each value in the collection corresponds to one attribute of the object.

Data set: a collection of data records.

Dimension: a collection of all the distinct values an object may have for one of its attributes.

Indexing dimension: a dimension corresponding to a data set, the dimension containing values that distinguish data records by virtue of distinguishing the objects those data records represent.

Hierarchy: a structure of values and categories containing those values, the structure having the following properties: 1) a category may contain zero or more values; 2) a category may contain zero or more other categories; 3) if a first category contains a second category, the first category also contains all the values and categories contained by the second category; 4) one of the categories, called the root, contains all other categories and all values in the structure, and is not contained by any other category; 5) each category, except the root, has exactly one parent, the parent of a first category being a second category that contains the first category but contains no other categories that also contain the first category; 6) each value has exactly one parent, which is a category that contains the value but contains no other categories that contain the value.

Hierarchy category: a category within a hierarchy.

Hierarchy node: a category or value within a hierarchy.

Hierarchy level: a set of all those hierarchy nodes in a hierarchy that are contained by the same number of hierarchy categories in the hierarchy.

Hierarchy expansion: a visual representation of a portion of a hierarchy, the portion consisting of a hierarchy category and one or more of those hierarchy nodes having the hierarchy category as a parent in the hierarchy, the visual representation having component visual representations of the hierarchy category and the hierarchy nodes, the component visual representations being displayed in such a manner that most viewers of the representation perceive the hierarchy nodes to have the hierarchy category as a parent.

Hierarchy retraction: a visual representation of a portion of a hierarchy, the portion consisting of a hierarchy category and one or more of those hierarchy nodes having the hierarchy category as a parent in the hierarchy, in which a visual representation of the hierarchy category is displayed, but no visual representation of the hierarchy nodes is displayed.

Hierarchical dimension: a dimension in which the dimension's values can be arranged into a hierarchy.

Axis: a geometric (not necessarily visible) line corresponding to one of the three spatial dimensions that exist in the natural world.

Label: one or more graphical or textual symbols that represent a value or a category of values; if the value or category of values represented by the label is a hierarchy node, the label may also represent the hierarchy node.

Labeled axis: a visual structure consisting of labels indicating partitions along an axis.

Grid: a visual structure existing on a 2-dimensional visual medium and having one or more labeled axes positioned orthogonally or approximately orthogonally to each other in one-, two- or three-dimensional space.

Grid cell: an area of visual space within a grid corresponding to exactly one of the partitions along each of the labeled axes comprising the grid.

Hierarchically-labeled axis: a labeled axis whose labels are visual representations of the hierarchy nodes of a hierarchy, the labeled axis having one partition for each label that represents a hierarchy node that does not contain a hierarchy node represented by another label.

Grid expansion: a grid with a corresponding hierarchy expansion, the grid having at least one hierarchically labeled axis in which some of the labels of the hierarchically-labeled axis constitute the corresponding hierarchy expansion, the grid having one grid cell per partition per grid axis.

Grid retraction: a grid with a corresponding hierarchy retraction, the grid having at least one hierarchically-labeled axis in which at least one of the labels of the hierarchically-labeled axis constitute the corresponding hierarchy retraction, the grid having one grid cell per partition per grid axis.

Grid cell level: a set of all those grid cells corresponding to partitions in a hierarchically-labeled axis, those partitions all having labels that represent hierarchy nodes belonging to the same hierarchy level in a hierarchy.

Visual characteristic: a visual property of a displayed line, such as color, shading, pattern, or thickness.

Composite grid cell: a grid cell that corresponds to at least one labeled-axis partition indicated by a label that represents a hierarchy category, as opposed to a value.

Atomic grid cell: a grid cell that corresponds only to labeled-axis partitions indicated by labels that represent values.

Expandable grid: a grid containing at least one grid expansion as a component.

Expanded hierarchy category: a hierarchy category that is represented visually in a hierarchy expansion, the hierarchy category being the parent of other hierarchy nodes represented in the hierarchy expansion.

Unexpanded hierarchy category: a hierarchy category that is represented visually in a hierarchy retraction, the hierarchy category being the parent of other hierarchy nodes that are not visually represented in the hierarchy retraction.

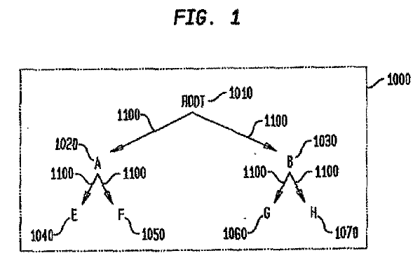

Referring to FIG. 1, there is depicted a hierarchy structure 1000 of values and categories with value “E” 1040, value “F” 1050, value “G” 1060, value “H” 1070, hierarchy category “A” 1020, hierarchy category “B” 1030, and root 1010. Arrows 1100 in FIG. 1 indicate that the hierarchy node at the origin of the arrow is the parent of the hierarchy node at the pointed end of the arrow. As shown, value “E” 1040 and value “F” 1050 have parent hierarchy category “A” 1020; likewise, value “G” 1060 and value “H” 1070 have parent hierarchy category “B” 1030, and hierarchy category “A” 1020 and hierarchy category “B” 1030 have parent root 1010. As shown in FIG. 1, value “E” 1040, value “F” 1050, value “G” 1060, and value “H” 1070 constitute one hierarchy level, while hierarchy category “A” 1020 and hierarchy category “B” 1030 constitute a second distinct hierarchy level, and root 1010 constitutes a third distinct hierarchy level.

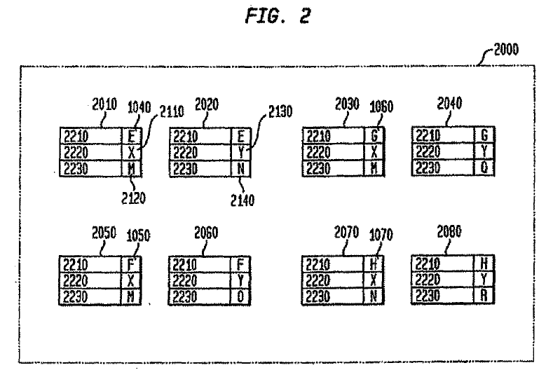

FIG. 2 depicts an exemplary multidimensional hierarchical data set 2000 having data records 2010, 2020, 2030, 2040, 2050, 2060, 2070, and 2080. Each data record represents an object, not pictured, having three attributes 2210, 2220, and 2230. Bach data record has three values, one value for each of the represented object's attributes. For example, data record 2010 has value “E” 1040, value “X” 2110, and value “M” 2120. Value “X” 2110 and value “Y” 2130 together constitute a dimension and an indexing dimension. Value “E” 1040, value “F” 1050, value “G” 1060, and value “H” 1070 together also constitute a dimension and an indexing dimension. The dimension constituted by value “E” 1040, value “F” 1050, value “G” 1060, and value “H” 1070 is also a hierarchical dimension, since, as depicted in FIG. 1, these values can be arranged into a hierarchy 1000. The multidimensional hierarchical data set in an example implementation, may comprise an enterprise privacy policy, which has at least 5 dimensions: Data Users, Actions, Data Categories, Purposes, and Conditions. Some of the dimensions in a privacy policy may be hierarchies; for instance, the Data Users in an enterprise may be all the enterprise employees, who are arranged in an organizational hierarchy. As another example of a hierarchical dimension, Data Categories may consist of Contact Information, which may comprise a name, address, and phone number, and Transaction Information, which might comprise Date, Time, and Transaction Type. Since such hierarchical dimensions may be huge, the visualization grid of the present invention enables the creation of a display showing all values of a particular dimension in a multidimensional hierarchical data set.

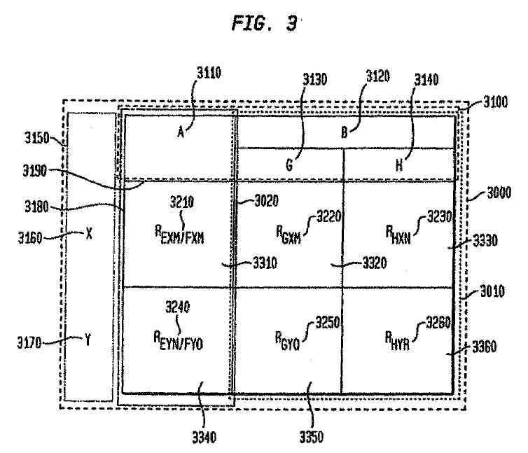

FIG. 3 depicts an example visualization grid 3000 generated in accordance with the current invention from the example data set 2000 shown in FIG. 2. As shown in FIG. 3, the grid 3000 includes two labeled axes 3100 and 3150. Labeled axis 3100 has label 3110 representing hierarchy category 1020 (FIG. 1), label 3120 representing hierarchy category 1030 (FIG. 1), label 3130 representing value 1060, and label 3140 representing value 1070, the labels indicating partitions along axis 3190. Labeled axis 3150 has label 3160 representing value 2110 and label 3170 representing value 2130, the labels indicating partitions along axis 3180. Labeled axis 3100 is a hierarchically-labeled axis.

Visualization grid 3000 has grid cells 3310, 3320, 3330, 3340, 3350, and 3360 containing visual representations 3210, 3220, 3230, 3240, 3250, and 3260. Visual representation 3210 represents data records 2010 and 2050 (FIG. 2); visual representation 3240 represents data records 2020 and 2060; visual representations 3220, 3230, 3250, and 3260 represent data records 2030, 2070, 2040, and 2080, respectively. Labels 3120, 3130, and 3140 together constitute a hierarchy expansion, label 3120 being a visual representation of expanded hierarchy category 1030 (e.g., hierarchical category “B”, FIG. 2), which is the parent of values 1060 and 1070 in hierarchy 1000. Label 3110 constitutes a hierarchy retraction, label 3110 being a visual representation of unexpanded hierarchy category 1020 (e.g., hierarchical category “A”, FIG. 2), which is the parent of values 1040 and 1050 in hierarchy 1000.

FIG. 3 additionally shows grid expansion 3010, with corresponding hierarchy expansion constituted by labels 3120, 3130, and 3140. FIG. 3 additionally shows grid retraction 3020 with corresponding hierarchy retraction constituted by label 3110.

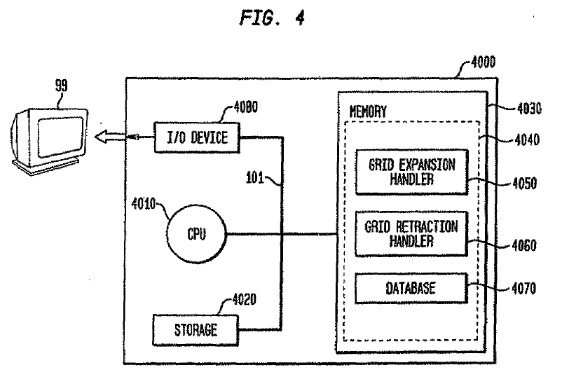

FIG. 4 depicts a block diagram of an example system 4000 adapted for implementing the visualization technique of the present invention. In the preferred embodiment, system implementation 4000 is a computing environment or computing node such as a personal computer (PC), workstation, mobile or laptop computer, or a pervasive digital device (e.g., PDA) that is able to load and execute programmatic code, including, but not limited to: products sold by IBM such as ThinkPad® or PowerPC®, running the operating system (O/S) and server application suite sold by Microsoft, e.g., Windows® XP, or a Linux operating system. It is understood that other operating systems including Linux, various Unix O/Ss, Macintosh, MS Windows OS, and the like, may be used to control execution of the visualization functionality of the invention. According to the present invention, the logic 4040 is preferably embodied as computer executable code that is loaded from a remote source (e.g., from a network file system), local permanent optical storage (CD-ROM), magnetic storage (such as disk), or Storage 4020 into memory 4030 (e.g., nonvolatile memory) for execution by a CPU 4010. As will be discussed in greater detail below, the memory 4030 preferably includes computer readable instructions, data structures, program modules, and application interfaces forming the following components: Grid Expansion Handler 4050, Grid Retraction Handler 4060, and Database 4070. An example of the database includes IBM's DB/2; however any database providing multidimensional sets of data for use with the invention whether local or remotely located can be used. Grid Expansion Handler 4050 is preferably a set of executable computer instructions for displaying a grid expansion given an unexpanded hierarchy category, while Grid Retraction Handler 4060 is preferably a set of executable computer instructions capable of displaying a grid retraction given an expanded hierarchy category.

The computer environment 4000 also includes a display device 99 or like monitor and associated I/O device, e.g., video adapter device 4080 that couples the display device 99 to a system bus 101 that connects various system components together. For instance, the bus 101 connects the CPU or like processor 4010 to the system memory 4030. The bus 101 can be implemented using any kind of bus structure or combination of bus structures, including a memory bus or memory controller, a peripheral bus, an accelerated graphics port, and a processor or local bus using any of a variety of bus architectures such as ISA bus, an Enhanced ISA (EISA) bus, and a Peripheral Component Interconnects (PCI) bus or like bus device. The computer node 4000 implements functionality for providing a user interface, including the various multidimensional data visualizations according to the invention, on the associated display device 99. Although not shown, the computing node 4000 includes other user input devices such as a keyboard, and a pointing device (e.g., a “mouse”) for entering commands and information into the computer (e.g., data storage devices), and, particularly, for manipulating the various multidimensional data visualizations enabled by the invention via a user interface generated on the display device 99. Particularly, a pointing device is utilized for controlling a graphics cursor for interacting with the generated display via the interface on display device 99 and may be used to generate input and commands for expanding or retracting the grid as will be explained in greater detail herein.

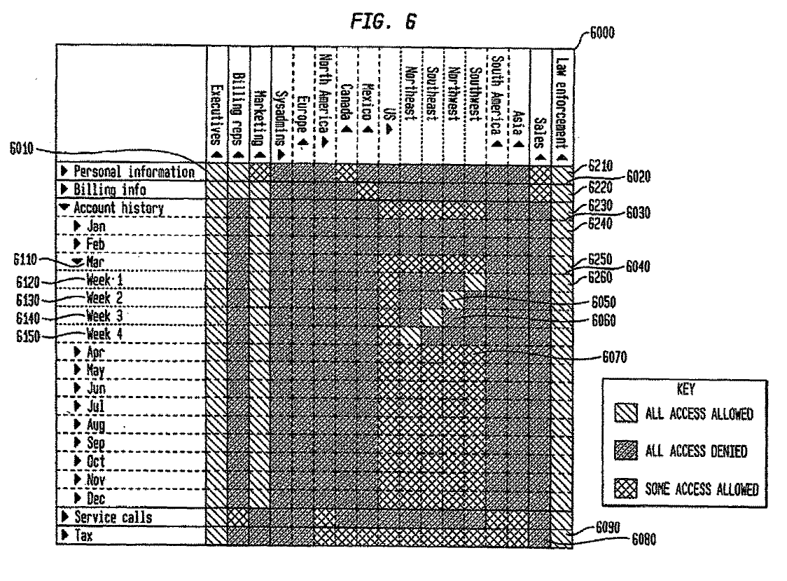

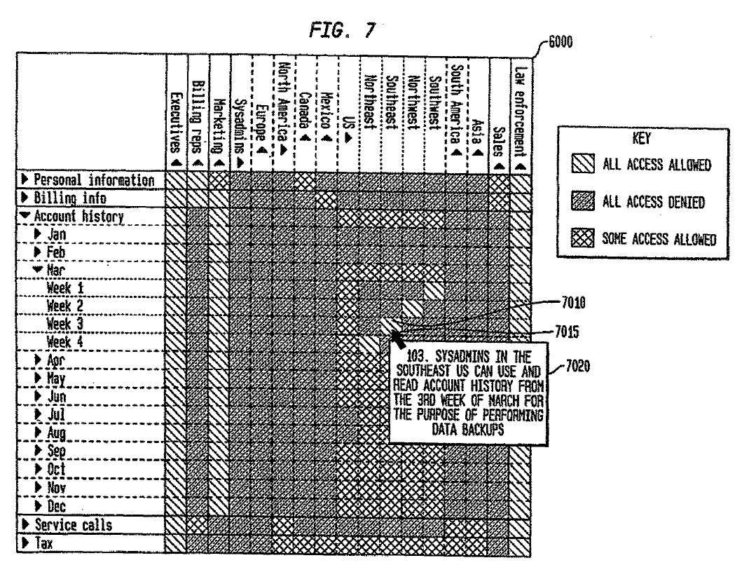

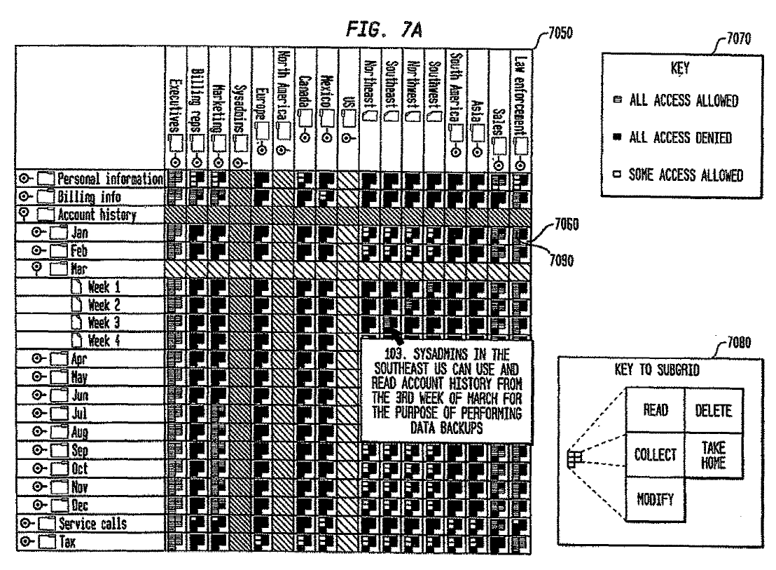

The computing environment depicted in FIG. 4 thus is enabled to access data from a multidimensional data set stored in database 4070 and display values from the data set in a table or grid such as will be described herein with respect to FIGS. 6, 7 and 7A. Data points displayed in the grid may be atomic, meaning they correspond to exactly one value in each dimension and hence are not further divisible in those dimensions, or, are composite, meaning they correspond to more than one atomic data point. An “atomic display key” dictates how atomic data points are displayed—they might be displayed as solid blocks of color, small grids of colors, text, or any other appropriate form that can be displayed in two (2) dimensions. A “composite display key” describes how composite data points are displayed—composite data points may be displayed in the same manner as atomic data points. However, since composite data points may be formed from arbitrary combinations of atomic data points, there are more display forms possible for composite data points than for atomic data points.

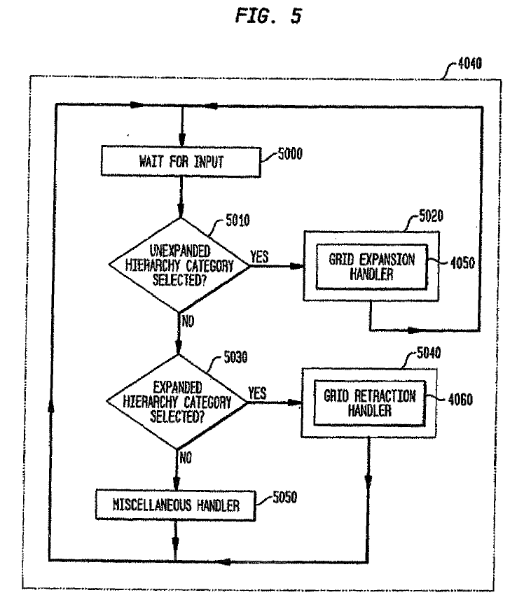

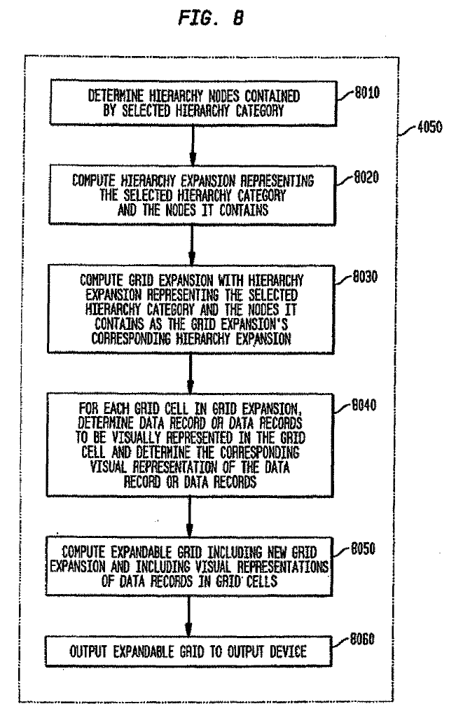

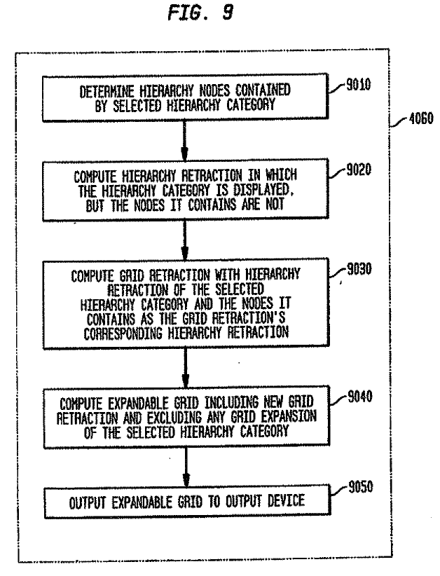

FIG. 5 is a flow chart depicting the flow control of the logic 4040 implemented for visualizing multidimensional data sets according to the current invention. As shown in FIG. 5, control starts at step 5000, which depicts the state of waiting for input. Upon receiving input, control advances to step 5010, where it is determined whether an unexpanded hierarchy category has been selected. If an unexpanded hierarchy category has been selected, control proceeds to step 5020, in which Grid Expansion Handler 4050 is invoked, following which control continues at step 5000. Details regarding the methodology invoked by the Grid Expansion Handler 4050 are described herein with reference to FIG. 8. Otherwise, if an expanded hierarchy category has been selected as determined by step 5030, control proceeds to step 5040, in which Grid Retraction Handler 4060 is invoked, following which control continues at step 5000. Details regarding the methodology invoked by the Grid Retraction Handler 4060 are described herein with reference to FIG. 9. Otherwise, control proceeds to step 5050, in which a miscellaneous handler beyond the scope of the current invention is invoked, following which control continues at step 5000.

FIG. 8 depicts a flow control of the detailed logic of Grid Expansion Handler 4050. As shown in FIG. 8, Grid Expansion Handler control starts at step 8010, an unexpanded hierarchy category having already been selected at step 5000 of FIG. 5. Step 8010 is to determine which hierarchy nodes are contained by the selected hierarchy category. Control then advances to step 8020 where functionality is executed to compute a hierarchy expansion representing the selected hierarchy category and the nodes it contains. Control then advances to step 8030 where functionality is executed to compute a grid expansion with the hierarchy expansion computed in step 8020 as the grid expansion's corresponding hierarchy expansion. Control then advances to step 8040 where functionality is executed to determine, for each grid cell in the grid expansion, the data record or data records to be visually represented in the grid cell and, to determine the corresponding visual representation of the data record or data records. Control then advances to step 8050 where functionality is executed to compute an expandable grid including the new grid expansion computed in step 8030 and including visual representations of data records in grid cells determined in step 8040. Step 8060 represents the step of outputting the expandable grid computed in step 8050 to output device 99 via I/O device 4080. Control will then advance out of the Grid Expansion Handler to step 5000 of FIG. 5.

FIG. 9 depicts a flow control of the detailed logic of Grid Retraction Handler 4060. As shown, Grid Retraction Handler control starts at step 9010, an expanded hierarchy category having already been selected at step 5000 of FIG. 5. Step 9010 is to determine the hierarchy nodes contained by the selected hierarchy category. Control then advances to step 9020 where functionality is executed to compute a hierarchy retraction in which the selected hierarchy category is displayed, but the nodes it contains are not. Control then advances to step 9030 where functionality is executed to compute a grid retraction with the hierarchy retraction computed in step 9020 as the grid retraction's corresponding hierarchy retraction. Control then advances to step 9040 where functionality is executed to compute an expandable grid including the new grid retraction computed in step 9030 and excluding any grid expansion of the selected hierarchy category. Control then advances to step 9050 where functionality is executed to output the expandable grid computed in step 9040 to output display device 99. Control then advances out of the Grid Retraction Handler to step 5000 of FIG. 5.

FIG. 6 depicts an example screen display output 6000 enabling the visualization of a multidimensional hierarchical data set as generated by the current invention. As shown in FIG. 6, lines 6020, 6030, and 6040 are displayed perpendicular to hierarchically-labeled axis 6010 of expandable grid 6000. Line 6020 indicates the visual boundary between grid cells 6210 and 6220. Line 6030 indicates the visual boundary between grid cells 6230 and 6240. Line 6040 indicates the visual boundary between grid cells 6250 and 6260. Grid cells 6210 and 6220 belong to a first grid cell level, while grid cells 6230 and 6240 belong to a second distinct grid cell level, and grid cells 6250 and 6260 belong to a third distinct grid cell level. Lines 6020, 6030, and 6040 thus indicate visual boundaries between grid cells belonging to different grid cell levels, and lines 6020, 6030, and 6040 have different visual characteristics; as shown, line 6020 is a solid line, line 6030 is a dashed line, and line 6040 is a dotted line in the exemplary display 6000 shown in FIG. 6.

Thus, the example display 6000 shown in FIG. 6 may represent the multidimensional hierarchical data set comprising an enterprise privacy policy, and is organized as a 2-dimensional table with Data Users along the x-axis and Data Categories along the y-axis. An example enterprise privacy policy may be embodied as a data set having at least five (5) dimensions: Data Users, Actions, Data Categories, Purposes, and Conditions. Some of the dimensions in a privacy policy may be hierarchies; for instance, the Data Users in an enterprise may be all the enterprise employees, who are arranged in an organizational hierarchy. As another example of a hierarchical dimension, Data Categories may consist of Contact Information, which consists of name, address, and phone number, and Transaction Information, which might consist of Date, Time, and Transaction Type.

As further shown in FIG. 6, the visual representation of composite grid cell 6070 is shown as an example checkerboard pattern. This composite grid cell pattern 6070 is visually distinct from the visual representation displayed in atomic grid cell 6050, a sparse dotted pattern, for example, and the visual representation displayed in atomic grid cell 6060, a diagonally striped pattern, for example. No atomic grid cell in expandable grid 6000 displays the same visual representation shown in composite grid cell 6070. However, composite grid cells 6080 and 6090 display the same visual representations displayed in cells 6060 and 6050, respectively. Thus, composite grid cells displaying visual representations of multiple data records that share an equal value for an attribute may have visual representations identical to the visual representation of a single data record shown in an atomic grid cell, but composite grid cells displaying visual representations of multiple data records having non-equal values for an attribute may have a visual representation different from the visual representation in any atomic grid cell.

As it may be useful to display a more detailed visual representation of one or more data records than can fit into a grid cell, the current invention includes a method for selecting a grid cell and displaying a larger visual representation of the data record or data records represented in the grid cell. FIG. 7 depicts an example screen display generated by the current invention in which a grid cell has been selected by on-screen cursor 7015 and a larger visual representation of the data record or data records represented in the grid cell is displayed. As shown in FIG. 7, grid cell 7010 has been selected and the large visual representation 7020 has been displayed.

As further shown in FIGS. 6 and 7 is the use of a key or legend that describes content of an individual grid cell structure. Thus, for purposes of illustration, it is assumed for the example multidimensional hierarchical data set representing an enterprise privacy policy described herein that a grid cell has a value of ALLOW or DENY for every combination of Data User and Data Category. In the example displayed grids of FIG. 6 and FIG. 7, the key describes the displayed atomic grid cell having sparse dotted pattern, for example, grid cell 6210, 6220, etc., as representing a value indicating that those users corresponding to the label “Law enforcement” are allowed access to information represented by that grid cell. Likewise, in the example displayed grids of FIG. 6 and FIG. 7, the key describes the displayed atomic grid cell having a diagonally striped pattern, for example, grid cell 6060, as representing a value indicating that those users corresponding to the label “Northwest” are denied access to information represented by that grid cell. Likewise, in the example displayed grids of FIG. 6 and FIG. 7, the key describes the displayed composite grid cells, for example, grid cell 6070, as representing a value indicating that those users are allowed access to some of the information represented by that grid cell. Taking grid cell 6070 as an example, grid cell 6070 represents policy rules related to sysadmins in the Southwest US in the Data User dimension and account history for the month of April in the Data Category dimension. The checkerboard pattern in grid cell 6070 indicates that those users who are sysadmins in the Southwest US can access some account history from the month of April; to see specifically what information these users can access, the “Apr” node along the grid's vertical axis could be selected for expansion, and, according to the present invention, the grid would expand to show specifically what information from the month of April can be accessed by sysadmins in the Southwest US.

It should be understood that rather than the use of geometric pattern to delineate grid cell attributes as in FIGS. 6 and 7, the grid and grid cells content may be suitably color coded, in which case the key would provide explanation of the colors as shown in the exemplary grid 7050 depicted in FIG. 7A. Thus, as shown in FIG. 7A, a visual representation contained in a grid cell can be divided into components to allow for distinguishing objects by one more dimension(s) than allowed by an expandable grid. Specifically, a visual representation in a grid cell can itself be a subgrid, the subgrid's cells each representing a value in a dimension and, the subgrid's cells each containing a visual representation of a data record having the value represented by the subgrid cell. Thus, as shown in FIG. 7A, each grid cell 7060 comprises a color-coded subgrid. The key structure 7070 shown in FIG. 7A will indicate the attribute value corresponding to the color used for the subgrid cell. The subgrid key structure 7080 shown in FIG. 7A will indicate the values in the particular dimension represented by the subgrid. In the example shown in FIG. 7A, example subgrid dimension values include “Read”, “Collect”, “Modify”, “Delete” and “Take home”. Thus, with reference to FIG. 7A, the atomic display key may indicate that ALLOW values may be displayed as colored green squares and DENY values may be displayed as red squares, for example. To illustrate what the key and subgrid key show, take subgrid cell 7090 as an example. Subgrid cell 7090 is located in the upper left corner of the subgrid in cell 7060. According to subgrid key 7080, the upper left corner of the subgrid represents the action “Read”. Thus, since grid cell 7060 represents the access allowed by users corresponding to the label “Law enforcement” to the information corresponding to the labels “Account history” and “Jan”, subgrid cell 7090 indicates permission for law enforcement to read account history data from January. Subgrid cell 7090 might be a green square, indicating, as shown by the key 7070, that access by law enforcement is allowed to read account history data from January.

As the present invention provides a method for allowing focus and context display of large multidimensional hierarchical data, it may be advantageously employed for viewing large policies, e.g., sets of rules that govern how allocation or access decisions are made. Some example policy domains are resource management policy, in which policies govern the allocation of supplies, services, money, or other resources to entities, privacy policy, in which policies govern who may access sensitive information under what conditions, and computer security policy, in which policies govern who may access computing resources.

For example, the above described example implementation of a multidimensional hierarchical data set may by used for viewing an enterprise privacy policy, having a privacy policy data set organized as a 2-dimensional table with Data Users along the x-axis and Data Categories along the y-axis. Given that Data Users may be organized into an enterprise organizational chart. It may well be a policy that, for a particular database of customer information, no employees under the CIO or the CFO are allowed to access the database, but that some employees under the COO can access parts of the database. For the purpose of displaying this policy, it is not necessary to expand the Data Users hierarchy beyond the level of CIO or CFO. However, it would be necessary to expand the Data Users hierarchy below the COO. The present invention describes a method for displaying some portions of a hierarchical dimension unexpanded while displaying other dimensions expanded.

It is understood that many other embodiments are imaginable. For example, besides implementation for visualizing an enterprise privacy policy, any sort of policy would be viewable in the same manner. Moreover, any multidimensional hierarchical data set—sales data, customer data, inventory data, and so on—is viewable in the same manner. In addition, the hierarchical dimensions along the x- and y-axes could be the same, allowing for viewing of large symmetrical datasets like social networks (what people communicate with what other people) or network traffic (what computers communicate with what other computers).

The invention has been described herein with reference to particular exemplary embodiments. Certain alterations and modifications may be apparent to those skilled in the art, without departing from the scope of the invention. The exemplary embodiments are meant to be illustrative, not limiting of the scope of the invention.

Having thus described our invention, what we claim as new, and desire to secure by Letters Patent is:

1. A method for visually representing a data set on a display device, said data set represented as a grid having at least one hierarchically-labeled axis, each of the grid's at least one labeled axes having labels that represent values or categories of the values of an indexing dimension corresponding to the data set, said grid comprising grid cells representing one or more data records of the data set, the method comprising:
displaying, on said display device, a hierarchy expansion of a portion of the hierarchy represented by a selected label;
displaying, on said display device, a grid expansion relating to said hierarchy expansion; and,
displaying, in one or more grid cells of said grid expansion, a visual representation of one or more data records having values represented by those labels that indicate axis partitions to which the grid cell corresponds.

2. The method as claimed in claim 1, further comprising:
selecting via said display device, a label of at least one of the hierarchically-labeled axes representing an unexpanded hierarchy category, and displaying said grid expansion in response to said selecting.

3. The method as claimed in claim 1, wherein said displaying a hierarchy expansion of a portion of the hierarchy comprises:
displaying, on said display device, the selected hierarchy category and those hierarchy nodes having the hierarchy category as a parent.

4. The method as claimed in claim 2, further comprising:
selecting a hierarchy category represented by a label of one of the grid's hierarchically-labeled axes;
retracting, on said display, that portion of the hierarchy represented by the labels of the hierarchically-labeled axis, the portion including the selected hierarchy category and those hierarchy nodes having the hierarchy category as a parent; and,
retracting, on said display, that corresponding grid expansion of the hierarchy.

5. The method as claimed in claim 1, wherein said visual representation of a displayed grid comprises:
lines displayed in a first orientation perpendicular to a hierarchically-labeled axis to indicate the visual boundaries between adjacent grid cells, said one or more lines indicating the visual boundaries belonging to different grid cell levels having different visual characteristics.

6. The method as claimed in claim 5, wherein a visual characteristic of a displayed line indicating visual boundaries between grid cells belonging to different grid cell levels comprises one or more of: a color, a shading, a pattern, or a thickness.

7. The method as claimed in claim 1, wherein a grid cell comprises an atomic grid cell corresponding to a labeled-axis partition indicated by a label that represents a value.

8. The method as claimed in claim 7, wherein a grid cell comprises a composite grid cell corresponding to at least one labeled-axis partition indicated by a label that represents a hierarchy category.

9. The method as claimed in claim 8, wherein a visual representation of data records within a displayed composite grid cell is visually distinct from all visual representations of data records displayed in atomic grid cells.

10. The method as claimed in claim 9, wherein a composite grid cell includes a subgrid cell structure for visually representing a value in a dimension, said subgrid cells each providing a visual representation of a data record having the value represented by the subgrid cell.

11. The method as claimed in claim 10, wherein a composite cell comprises a color-coded subgrid.

12. The method as claimed in claim 1, further comprising:
selecting a grid cell;
displaying a visual representation of one or more of those data records in the selected grid cell, wherein the displayed visual representation of the data records in said selected grid cell is visually larger than the representation of the data record in an unselected grid cell.

13. The method as claimed in claim 1, further comprising:
selecting a dimension from a data set;
selecting an axis;
removing from said displayed visual representation any labels displayed on the selected axis;
displaying labels representing values and categories in the selected dimension along the selected axis;
updating the grid to have one grid cell per partition per grid axis; and,
updating the grid to display, in one or more grid cells that are part of the grid, a visual representation of one or more data records having values represented by those labels that indicate the axis partitions to which the grid cell corresponds.

14. A program storage device readable by a machine, tangibly embodying a program of instructions executable by the machine to perform method steps for visually representing a data set on a display device, said data set represented as a grid having at least one hierarchically-labeled axis, each of the grid's at least one labeled axes having labels that represent values or categories of the values of an indexing dimension corresponding to the data set, said grid comprising grid cells representing one or more data records of the data set, the method comprising:
displaying, on said display device, a hierarchy expansion of a portion of the hierarchy represented by a selected label;
displaying, on said display device, a grid expansion relating to said hierarchy expansion; and,
displaying, in one or more grid cells of said grid expansion, a visual representation of one or more data records having values represented by those labels that indicate axis partitions to which the grid cell corresponds.

15. The program storage device readable by a machine as claimed in claim 14, further comprising: selecting via said display device, a label of at least one of the hierarchically-labeled axes representing an unexpanded hierarchical category, and displaying said grid expansion in response to said selecting.

16. The program storage device readable by a machine as claimed in claim 14, wherein said displaying a hierarchy expansion of a portion of the hierarchy comprises:
displaying, on said display device, the selected hierarchy category and those hierarchy nodes having the hierarchy category as a parent.

17. The program storage device readable by a machine as claimed in claim 16, further comprising:
selecting a hierarchy category represented by a label of one of the grid's hierarchically-labeled axes;
retracting, on said display, that portion of the hierarchy represented by the labels of the hierarchically-labeled axis, the portion including the selected hierarchy category and those hierarchy nodes having the hierarchy category as a parent; and,
retracting, on said display, that corresponding grid expansion of the hierarchy.

18. The program storage device readable by a machine as claimed in claim 14, wherein said visual representation of a displayed grid comprises:
lines displayed in a first orientation perpendicular to a hierarchically-labeled axis to indicate the visual boundaries between adjacent grid cells, said one or more lines indicating the visual boundaries belonging to different grid cell levels having different visual characteristics.

19. The program storage device readable by a machine as claimed in claim 18, wherein a visual characteristic of a displayed line indicating visual boundaries between grid cells belonging to different grid cell levels comprises one or more of: a color, a shading, a pattern, or a thickness.

20. The program storage device readable by a machine as claimed in claim 14, wherein a grid cell comprises one of: an atomic grid cell corresponding to a labeled-axis partition indicated by a label that represents a value, or, a composite grid cell corresponding to at least one labeled-axis partition indicated by a label that represents a hierarchy category, a visual representation of data records within a displayed composite grid cell being visually distinct from all visual representations of data records displayed in atomic grid cells.

21. A system for visually representing a data set on a display device, said data set represented as a grid having at least one hierarchically-labeled axis, each of the grid's at least one labeled axes having labels that represent values or categories of the values of an indexing dimension corresponding to the data set, said grid comprising grid cells representing one or more data records of the data set, the system comprising:
means enabling selecting, via said display device, a label of at least one of the hierarchically-labeled axes representing an unexpanded hierarchical category;
processor means for computing a hierarchy expansion of a portion of the hierarchy represented by said selected label, said processor means further computing a grid expansion relating to said hierarchy expansion;
means for displaying, on said display device, said hierarchy expansion, and, said related grid expansion,
wherein said means for displaying, displays further, in one or more grid cells of said grid expansion, a visual representation of one or more data records having values represented by those labels that indicate axis partitions to which the grid cell corresponds.

22. The system as claimed in claim 21, wherein said means for displaying a hierarchy expansion of a portion of the hierarchy further displays the selected hierarchy category and those hierarchy nodes having the hierarchy category as a parent.

23. The system as claimed in claim 22, wherein said means for selecting further enables: selection of a hierarchy category represented by a label of one of the grid's hierarchically-labeled axes, said processor means computing a portion including the selected hierarchy category and those hierarchy nodes having the hierarchy category as a parent, and said displaying means retracting, on said display, that corresponding grid expansion of the hierarchy.
